(19) United States
(12) Patent Application Publication
(10) Pub. No.: US 2026/0128555 A1
(43) Pub. Date: May 7, 2026

(54) CONNECTOR STRUCTURE

(71) Applicant: YAZAKI CORPORATION, Tokyo (JP)

(72) Inventors: Noriyoshi Yamanishi, Kakegawa-shi (JP); Shoya Ueda, Kakegawa-shi (JP)

(21) Appl. No.: 19/379,411

(22) Filed: Nov. 4, 2025

(30) Foreign Application Priority Data
Nov. 5, 2024 (JP) 2024-193380

(51) Int. Cl. H01R 13/66; H01R 13/405

(52) U.S. Cl. CPC H01R 13/6683; H01R 13/405

(57) ABSTRACT

A connector structure includes a case that holds a terminal, a thermistor capable of detecting a temperature of the terminal, and a thermistor holder that brings the thermistor into close contact with the terminal, in which the case includes an insulating cylindrical portion into which the thermistor holder is inserted, and a notch is formed in the cylindrical portion, the notch being open to allow the thermistor holder to be pushed in when the thermistor holder is inserted.

### BACKGROUND OF THE INVENTION

### Field of the Invention

Embodiments of the present invention relate to a connector structure.

Priority is claimed on Japanese Patent Application No. 2024-193380 filed in Japan on November 5, 2024, the content of which is incorporated herein by reference.

### Description of Related Art

Connectors are known that include terminals to be connected to electric wires and a housing in which the terminals are housed. A thermistor is attached to an outer peripheral surface of the terminal.

### Prior Art Document

### Patent Document

Patent Document 1: Japanese Unexamined Patent Application, First Publication No. 2023-3340

### SUMMARY OF THE INVENTION

When assembling a thermistor holder that brings a thermistor into close contact with a terminal, the assembling process can be difficult in some cases.

One embodiment provides a connector structure that allows for easy assembly of a thermistor holder.

A connector structure according to one embodiment includes a case that holds a terminal, a thermistor capable of detecting a temperature of the terminal, and a thermistor holder that brings the thermistor into close contact with the terminal, in which the case includes an insulating cylindrical portion into which the thermistor holder is inserted, and a notch is formed in the cylindrical portion, the notch being open to allow the thermistor holder to be pushed in when the thermistor holder is inserted.

According to one embodiment, the thermistor holder can be easily assembled.

### BRIEF DESCRIPTION OF THE DRAWINGS

FIG. 1 is a perspective view illustrating a connector structure according to an embodiment.

FIG. 2 is a plan view illustrating the connector structure according to the embodiment.

FIG. 3 is a cross-sectional view taken along line III-III of FIG. 2.

FIG. 4 is an enlarged perspective view illustrating a cylindrical portion of the embodiment.

FIG. 5 is a perspective view illustrating a method of assembling a thermistor holder of the embodiment.

FIG. 6 is a perspective view illustrating a method of assembling the thermistor holder, following FIG. 5.

FIG. 7 is a cross-sectional view illustrating a case where the thermistor holder is inserted into a cylindrical portion of a comparative example.

FIG. 8 is a cross-sectional view illustrating a case where the thermistor holder is inserted, following FIG. 7.

FIG. 9 is a cross-sectional view illustrating a case where the thermistor holder is inserted into the cylindrical portion of the embodiment.

FIG. 10 is a cross-sectional view illustrating a case where the thermistor holder is inserted into the cylindrical portion, following FIG. 9.

### DETAILED DESCRIPTION OF THE INVENTION

Hereinafter, embodiments will be described with reference to the drawings. In the following description, expressions indicating relative or absolute arrangements, such as “parallel,” “orthogonal,” “center,” and “coaxial,” do not only mean such arrangements or states in a strict sense, but also include arrangements or states in which there is a relative displacement with an angle or distance to the extent that a tolerance or the same function can be obtained. In the drawings used in the following description, the scale of each member may be changed as appropriate to make each member recognizable.

### Connector Structure

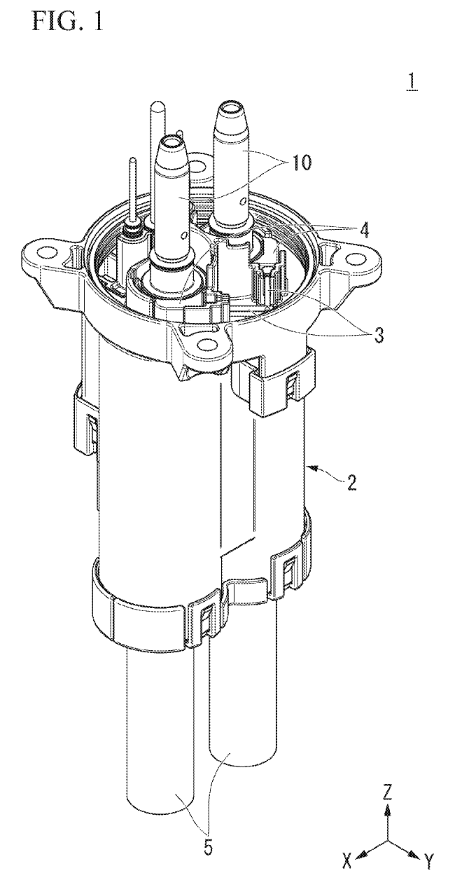

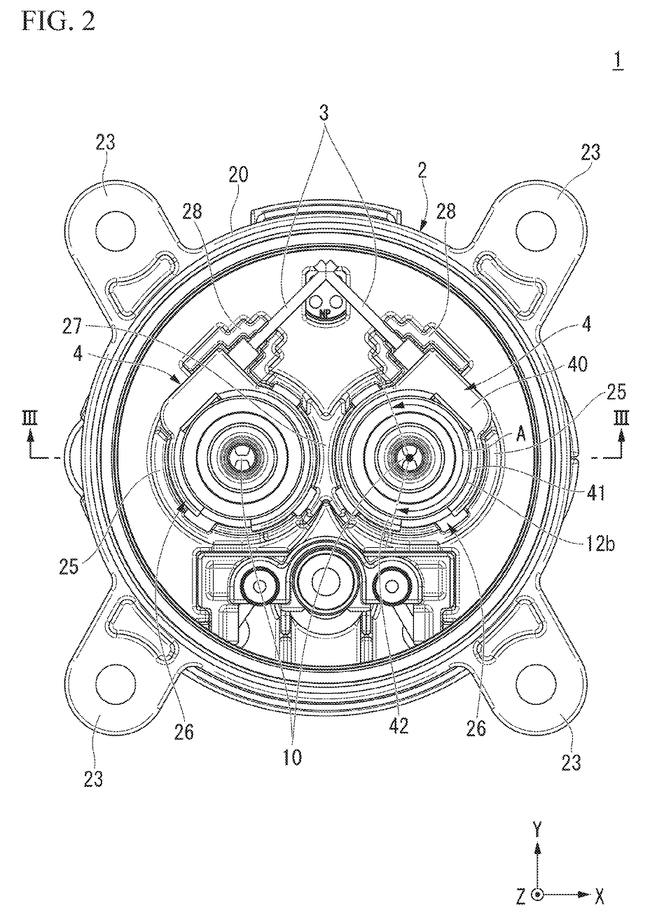

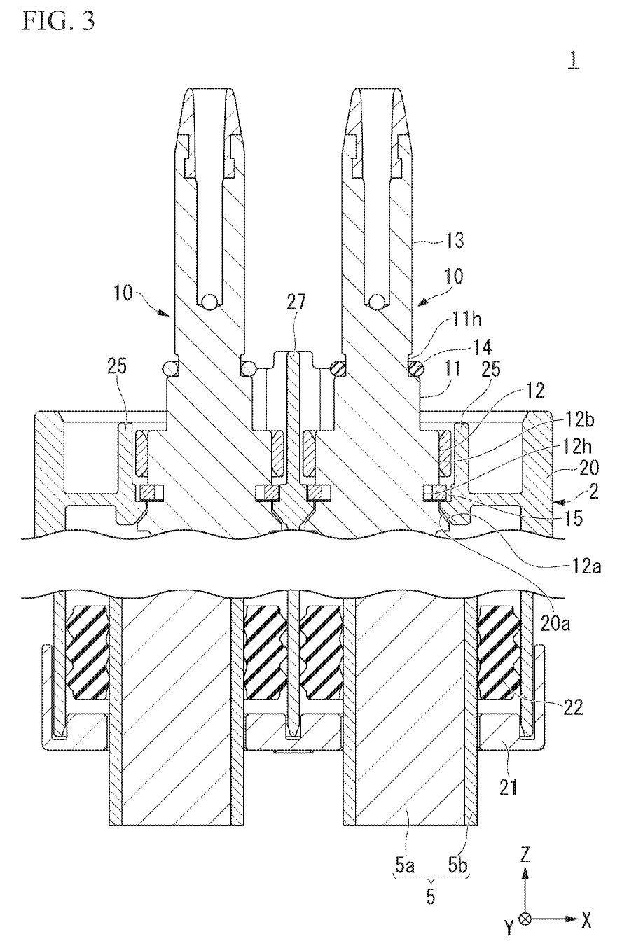

FIG. 1 is a perspective view illustrating a connector structure 1 according to an embodiment. FIG. 2 is a plan view illustrating the connector structure 1 according to the embodiment. FIG. 3 is a cross-sectional view taken along line III-III of FIG. 2.

Referring to FIGS. 1 to 3 together, the connector structure 1 includes a case 2 that holds a terminal 10, a thermistor 3 that can detect the temperature of the terminal 10, and a thermistor holder 4 that brings the thermistor 3 into close contact with the terminal 10.

The connector structure 1 is installed in a vehicle, such as an electric vehicle or a plug-in hybrid vehicle, in order to supply (charge) electric power from outside the vehicle to a battery mounted on the vehicle. The connector structure 1 is connected to an electric wire 5 extending from a battery mounted on a vehicle. The connector structure 1 constitutes a charging inlet. By fitting a mating connector (for example, a charging gun) into the connector structure 1, electric power is supplied to the battery from outside the vehicle, and the battery is charged.

In the following description, an orthogonal coordinate system of X, Y, and Z will be used as necessary. The Z direction corresponds to an axial direction of a cylindrical portion 25, which will be described later. The X direction corresponds to a direction in which a pair of cylindrical portions 25, which will be described later, are adjacent to each other. The Y direction is a direction orthogonal to the X direction and the Z direction. In the following description, of the X direction, the Y direction, and the Z direction, the arrow side in the drawing will be referred to as a plus (+) side, and the side opposite to the arrow will be referred to as a minus (-) side. The Z direction coincides with the fitting direction of the connector structure 1 and the mating connector (not illustrated). The +Z side corresponds to the front side in the fitting direction (the side approaching the mating connector, the front side) when viewed from the connector structure 1. The -Z side corresponds to the release side in the fitting direction (the side away from the mating connector, the rear side) when viewed from the connector structure 1.

### Terminal

The terminal 10 is made of metal. The terminals 10 are provided in pairs. One end portion of a pair of electric wires 5 is connected to each of the pair of terminals 10. The other end portion of the pair of electric wires 5 is connected to a battery (not illustrated). The electric wire 5 includes a conductor core wire 5a and an insulating coating 5b that covers the conductor core wire 5a (see FIG. 3).

The pair of terminals 10 have, for example, the same shape. The terminal 10 extends in the Z direction. The terminal 10 has a columnar shape. Specifically, the terminal 10 has a stepped columnar portion including a small diameter portion 11 and a large diameter portion 12 having an outer diameter larger than that of the small diameter portion 11 (see FIG. 3).

The pair of terminals 10 include a cylindrical male terminal portion 13 that protrudes in the +Z direction from the +Z end face of the small diameter portion 11. The male terminal portion 13 of one terminal 10 of the pair of terminals 10 functions as an anode terminal. The male terminal portion 13 of the other terminal 10 of the pair of terminals 10 functions as a cathode terminal. When the connector structure 1 is fitted to a mating connector, the male terminal portion 13 of one terminal 10 is connected to a female terminal portion on the anode side of the mating connector. When the connector structure 1 is fitted to the mating connector, the male terminal portion 13 of the other terminal 10 is connected to a female terminal portion on the cathode side of the mating connector.

For example, the -Z end face of the large diameter portion 12 is formed with a recess (not illustrated) recessed in the +Z direction. The conductor core wire 5a exposed at one end portion of the electric wire 5 is inserted into this recess and fixed by crimping. By this crimping, one end portion of the electric wire 5 and the terminal 10 are electrically connected.

As illustrated in FIG. 3, an annular groove 11h is formed at a boundary between the small diameter portion 11 and the male terminal portion 13. For example, an O-ring 14 is attached to the annular groove 11h. The O-ring 14 is provided, for example, at a boundary between the small diameter portion 11 and a front cover (not illustrated).

For example, at a boundary between the large diameter portion 12 and the case 2, a step portion 12a and an annular groove 12h are formed. The step portion 12a is locked to a locking projection 20a of a case body 20, which will be described later. The annular groove 12h is formed on the outer peripheral surface of the large diameter portion 12 near the +Z side of the step portion 12a. For example, a lock piece 15 is attached to the annular groove 12h. The lock piece 15 has the function of restricting the position of the terminal 10 together with the step portion 12a and the locking projection 20a. The function of the lock piece 15 and the like prevents the terminal 10 from being displaced relative to the case 2.

### Case

As illustrated in FIG. 3, the case 2 includes, for example, a case body 20 and a rear cover 21. The case body 20 is made of, for example, resin. The case body 20 has through holes formed therein for passing the pair of terminals 10 and the pair of electric wires 5 therethrough. The case body 20 has a shape that is long in the Z direction. In FIG. 3, the central portion of the case body 20 in the Z direction is omitted.

The case body 20 has a function of holding the pair of terminals 10 and the pair of electric wires 5. The +Z side portion of the case body 20 has the function of holding the pair of terminals 10 in a mutually insulated state with an interval therebetween in the X direction. The -Z side portion of the case body 20 has the function of holding the pair of electric wires 5 extending from the pair of terminals 10 to the -Z side with an interval therebetween in the X direction.

For example, a packing 22 having a waterproof function is provided between the inner wall surface of the -Z side portion of the case body 20 and the outer peripheral surface of the electric wire 5 (coating 5b). The function of the packing 22 is to prevent water from entering the inside of the case 2 (the connection portion between the conductor core wire 5a of the electric wire 5 and the terminal 10) from the outside.

The rear cover 21 is assembled to the case body 20 from the -Z side (rear side). The rear cover 21 is made of, for example, resin. A front cover (not illustrated) is assembled to the case body 20 from the +Z side (front side). The outer wall portion of the case body 20 is provided with bolt insertion portions 23 which are provided in a plurality of locations (for example, four locations) and through which bolts for assembling the front cover are inserted (see FIG. 2).

### Thermistor

As illustrated in FIG. 2, a pair of thermistors 3 are provided corresponding to each of the pair of terminals 10. The thermistor 3 is attached to the terminal 10 by the thermistor holder 4. The thermistor 3 is attached to a part of the large diameter portion 12 of the terminal 10 that extends from the case body 20 to the +Z side (hereinafter also referred to as an “attached portion 12b”).

By attaching the thermistor 3 to the pair of terminals 10, the temperature of the pair of terminals 10 can be detected. By detecting the temperature of the pair of terminals 10, it becomes possible to monitor the transition of the temperature of the pair of terminals 10 when the connector structure 1 is in use (for example, when charging a battery).

### Thermistor Holder

As illustrated in FIG. 2, the thermistor holder 4 includes a holder body 40 that holds the thermistor 3, and a pair of holding portions 41 and 42 that extend from the holder body 40 and hold the terminal 10. The pair of holding portions 41 and 42 are formed in an arc shape that follows the outer periphery of the terminal 10 (attached portion 12b) when viewed from the Z direction. Before the thermistor holder 4 is assembled to the terminal 10, the radius of curvature of the arc-shaped portions (inner peripheral surfaces) of the pair of holding portions 41 and 42 is smaller than the outer diameter of the terminal 10 (attached portion 12b).

The pair of holding portions 41 and 42 have, for example, different lengths (lengths along the outer periphery of the terminal 10 when viewed from the Z direction). In the example of FIG. 2, the length of the holding portion 41 on the outer side in the X direction is shorter than the length of the holding portion 42 on the inner side in the X direction (on a wall portion 27 side). The pair of holding portions 41 and 42 may have the same length. The length of each of the holding portions 41 and 42 can be changed according to design specifications.

The thermistor holder 4 brings the thermistor 3 into close contact with the terminal 10 by a reaction force generated when the thermistor holder 4 is pushed outward during assembly to the terminal 10. The thermistor holder 4 includes arc-shaped holding portions 41 and 42 that follow the outer periphery of the terminal 10. The thermistor holder 4 brings the thermistor 3 into close contact with the terminal 10 by a reaction force generated when the holding portions 41 and 42 are pushed outward during assembly to the terminal 10. In a state where the thermistor holder 4 is assembled, the thermistor 3 is in close contact with the attached portion 12b by the reaction force of the pair of holding portions 41 and 42.

### Cylindrical Portion

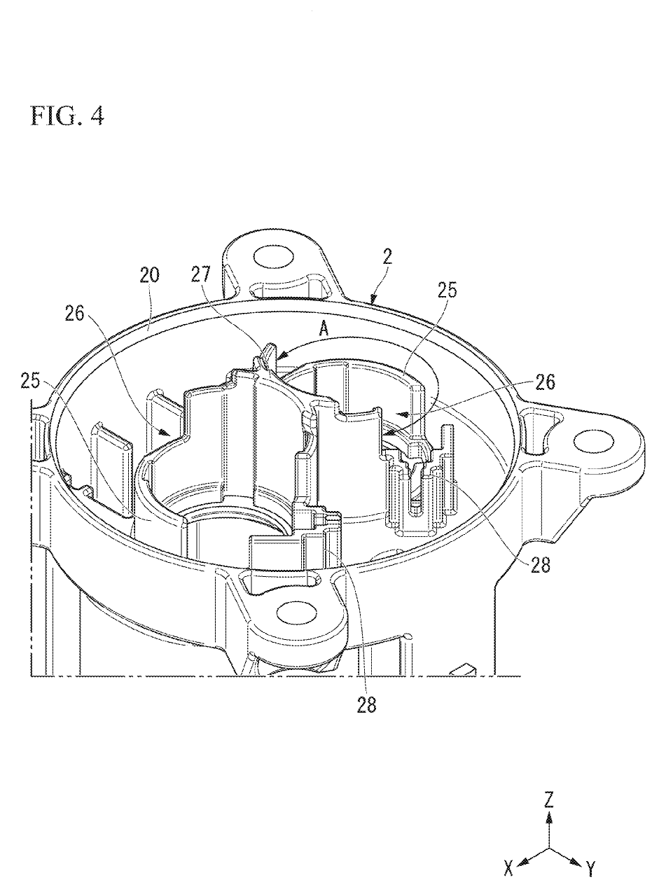

FIG. 4 is an enlarged perspective view of the cylindrical portion 25 of the embodiment.

Referring to FIGS. 2 to 4 together, the case 2 includes an insulating cylindrical portion 25 into which the thermistor holder 4 is inserted. At least a part of the cylindrical portion 25 is formed in a cylindrical shape that conforms to the outer shape of the terminal 10 when viewed from the Z direction. The cylindrical portion 25 is provided on the case body 20. The cylindrical portion 25 extends in the +Z direction from the periphery of the through hole in the case body 20 through which the terminal 10 passes. A pair of cylindrical portions 25 are provided adjacent to each other. The pair of cylindrical portions 25 have the same height in the Z direction, for example.

The case 2 further includes an insulating wall portion 27 at a portion where the pair of cylindrical portions 25 are adjacent to each other. The wall portion 27 is provided at the center between the pair of terminals 10 in the X direction. The wall portion 27 is higher than the pair of cylindrical portions 25 in the Z direction. The +Z side end portion of the wall portion 27 is disposed on the +Z side of the +Z side end portion of each of the pair of cylindrical portions 25.

The case 2 is provided with inserted portions 28 into which the pair of thermistors 3 and a part of the pair of thermistor holders 4 are inserted from the +Z side. The inserted portion 28 has an inner surface that conforms to the outer shapes of the thermistor 3 and a part of the thermistor holder 4 when viewed from the Z direction. The inserted portion 28 has the function of restricting displacement of the thermistor 3 and the thermistor holder 4 in the X and Y directions (displacement in directions other than the +Z direction). The inserted portion 28 functions to prevent the thermistor 3 and the thermistor holder 4 from being displaced in the X and Y directions.

### Notch

Referring to FIGS. 2 to 4 together, a notch 26 is formed in the cylindrical portion 25, the notch being open to allow the thermistor holder 4 to be pushed in when the thermistor holder 4 is inserted. The notches 26 are formed in each of the pair of

cylindrical portions 25. The notch 26 is formed in a portion different from the portion where the pair of cylindrical portions 25 are adjacent to each other. The notch 26 is formed in a portion different from the wall portion 27.

The notches 26 are formed at least at positions facing each other in a direction intersecting the axial direction of the cylindrical portion 25. The notches 26 are formed at least at positions facing each other across the terminal 10 in the radial direction of the cylindrical portion 25 (direction orthogonal to the axial direction of the cylindrical portion 25). The notch 26 is formed by opening a part of the cylindrical portion 25 in both the radial direction and the +Z direction of the cylindrical portion 25.

The notch 26 is formed in a range of a central angle of 180 degrees or more when viewed from the axial direction of the cylindrical portion 25. In FIGS. 2 and 4, the range in which the notch 26 is formed is indicated by a central angle A. The notch 26 may be formed, for example, in a semicircular shape when viewed from the axial direction (Z direction) of the cylindrical portion 25, or in a fan shape with a central angle of 180 degrees or more. The shape of the notch 26 is not limited to the above and can be changed according to design specifications.

The range in which the notch 26 is formed, for example, when viewed from the axial direction of the cylindrical portion 25, is more preferably a central angle of 210 degrees or more, and still more preferably a central angle of 240 degrees or more. The lower limit value of the range in which the notch 26 is formed is not limited to the above and can be changed according to the design specifications. The lower limit value of the range in which the notch 26 is formed needs only to be set so that the thermistor holder 4 can be pushed in when the thermistor holder 4 is inserted.

For example, the upper limit value of the range in which the notch 26 is formed needs only to be set to such an extent that the strength and rigidity of the cylindrical portion 25 can be ensured. The range in which the notch 26 is formed may be, for example, a central angle of 330 degrees or less when viewed from the axial direction of the cylindrical portion 25. The upper limit value of the range in which the notch 26 is formed is not limited to the above and can be changed according to the design specifications.

### Method of Assembling Thermistor Holder

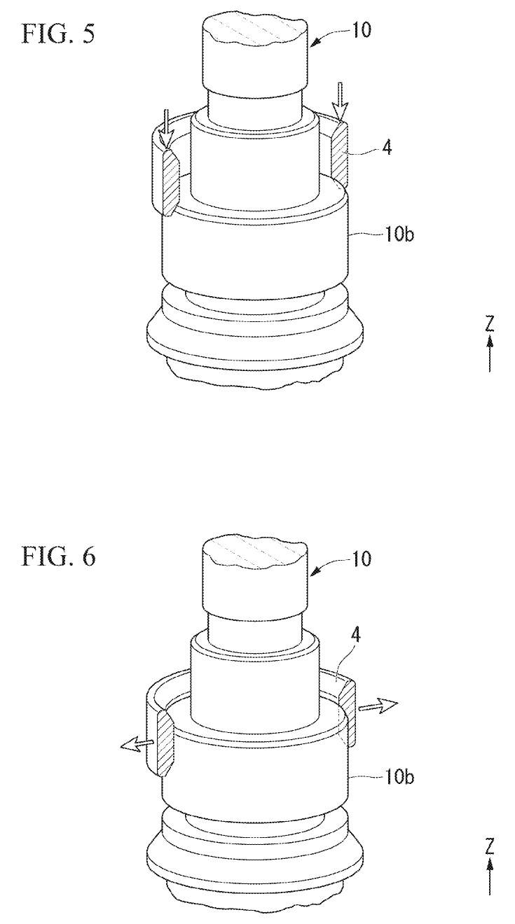

FIG. 5 is a perspective view illustrating a method of assembling the thermistor holder 4 of the embodiment. FIG. 6 is a perspective view illustrating a method of assembling the thermistor holder 4, following FIG. 5.

As described above, before the thermistor holder 4 is assembled to the terminal 10, the radius of curvature of the arc-shaped portions (inner peripheral surfaces) of the pair of holding portions 41 and 42 is smaller than the outer diameter of the terminal 10 (attached portion 12b). The thermistor holder 4 is assembled to the terminal 10 in a state where the front cover (not illustrated) and the like are removed from the case body 20.

When assembling the thermistor holder 4 to the terminal 10, the thermistor holder 4 is pushed in the direction of the arrow (-Z direction) illustrated in FIG. 5. Then, the thermistor holder 4 (for example, the pair of holding portions 41 and 42) is pushed open in the direction of the arrows illustrated in FIG. 6 (outward in the radial direction of the terminal 10). The reaction force generated when the thermistor holder 4 is pushed open causes the thermistor 3 to be brought into close contact with the terminal 10 (attached portion 12b).

### Case Where Thermistor Holder Is Inserted into Cylindrical Portion of Comparative Example

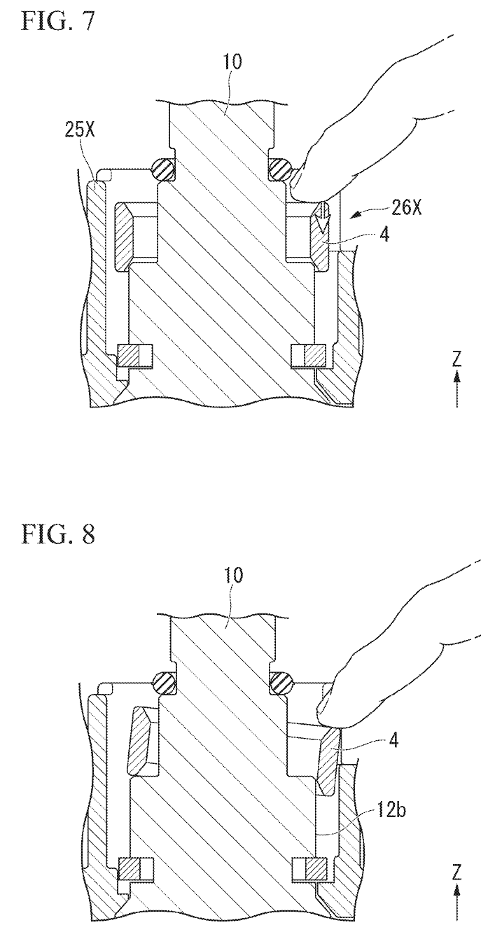

FIG. 7 is a cross-sectional view illustrating a case where the thermistor holder 4 is inserted into a cylindrical portion 25X of a comparative example. FIG. 8 is a cross-sectional view illustrating a case where the thermistor holder 4 is inserted, following FIG. 7.

In the comparative example, a notch 26X is formed at a position (one location) on one side (one radial side of the terminal 10) in a direction intersecting the axial direction of the cylindrical portion 25X.

In the comparative example, when the thermistor holder 4 is assembled to the terminal 10, the thermistor holder 4 is pushed in from one radial side of the terminal 10 in the direction of the arrow (-Z direction) illustrated in FIG. 7. Then, it is difficult to push the thermistor holder 4 parallel to the Z direction, and the thermistor holder 4 is inclined as illustrated in FIG. 8. When the thermistor holder 4 is inclined, it becomes difficult to assemble (attach the thermistor holder 4 to the attached portion 12b).

### Case Where Thermistor Holder Is Inserted into Cylindrical Portion of Embodiment

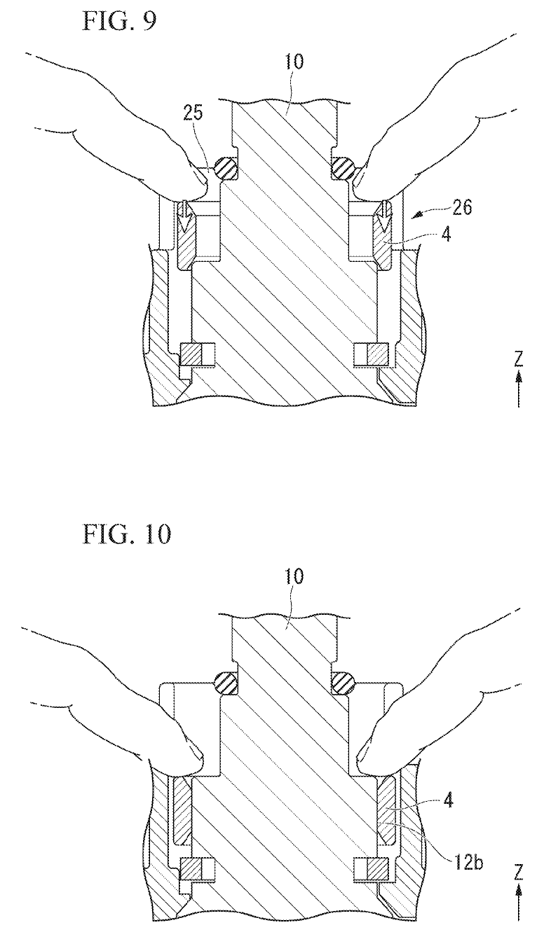

FIG. 9 is a cross-sectional view illustrating a case where the thermistor holder 4 is inserted into the cylindrical portion 25 of the embodiment. FIG. 10 is a cross-sectional view illustrating a case where the thermistor holder 4 is inserted into the cylindrical portion 25, following FIG. 9.

As described above, in the embodiment, the notches 26 are formed at least at positions facing each other in a direction intersecting the axial direction of the cylindrical portion 25. The notch 26 is formed, for example, in a semicircular shape when viewed from the axial direction of the cylindrical portion 25, or in a fan shape with a central angle of 180 degrees or more.

In the embodiment, when the thermistor holder 4 is assembled to the terminal 10, the thermistor holder 4 can be pushed in from both radial sides of the terminal 10 in the direction of the arrow (-Z direction) illustrated in FIG. 9. In the embodiment, for example, a worker can press both of the portions of the thermistor holder 4 that face each other with the terminal 10 being interposed therebetween with his or her fingers. By pushing the thermistor holder 4 in from both radial sides of the terminal 10, it is possible to push the thermistor holder 4 in while maintaining parallelism in the Z direction, as illustrated in FIG. 10. In the embodiment, inclination of the thermistor holder 4 is suppressed, which facilitates assembly (attachment to the attached portion 12b).

When assembling the thermistor holder 4 to the terminal 10, the worker does not necessarily have to push the thermistor holder 4 in with his or her fingers. For example, the worker may use a tool, a machine, or the like to push the thermistor holder 4 in. The manner in which the thermistor holder 4 is pushed in can be changed according to the design specifications.

### Operation and Effects

As described above, the connector structure 1 according to the present embodiment includes a case 2 that holds a terminal 10, a thermistor 3 that can detect the temperature of the terminal 10, and a thermistor holder 4 that brings the thermistor 3 into close contact with the terminal 10. The case 2 includes an insulating cylindrical portion 25 into which the thermistor holder 4 is inserted. A notch 26 is formed in the cylindrical portion 25, the notch being open to allow the thermistor holder 4 to be pushed in when the thermistor holder 4 is inserted. According to this configuration, when the thermistor holder 4 is inserted, the thermistor holder 4 can be pushed in through the notch 26 of the cylindrical portion 25. Therefore, the thermistor holder 4 can be easily assembled. In addition, assembling the thermistor holder 4 does not require time or skill.

In the present embodiment, the notches 26 are formed at least at positions facing each other in a direction intersecting the axial direction of the cylindrical portion 25. According to this configuration, the thermistor holder 4 can be pushed in through the notches 26 formed in the cylindrical portion 25 at positions facing each other. Therefore, the thermistor holder 4 can be more easily assembled.

In the present embodiment, the notch 26 is formed in a range of a central angle of 180 degrees or more when viewed from the axial direction of the cylindrical portion 25. According to this configuration, the thermistor holder 4 can be pushed in through a wider range of the notch 26 as compared with the case where the notch 26 is formed in a range with a central angle of less than 180 degrees. Therefore, the thermistor holder 4 can be more easily assembled.

In the present embodiment, a pair of cylindrical portions 25 are provided adjacent to each other. The notch 26 is formed in a portion different from the portion where the pair of cylindrical portions 25 are adjacent to each other. According to this configuration, the notch 26 is not required in the portion where the pair of cylindrical portions 25 are adjacent to each other, and therefore there is no need for a space for the worker to push in with his or her fingers. With this saved space, the interval between the pair of cylindrical portions 25 adjacent to each other can be shortened. Therefore, the connector structure 1 can be prevented from becoming large.

In the present embodiment, the case 2 further includes an insulating wall portion 27 at a portion where the pair of cylindrical portions 25 are adjacent to each other. According to this configuration, the wall portion 27 can ensure insulation between the adjacent portions of the pair of cylindrical portions 25. In addition, the wall portion 27 can ensure the strength and rigidity of the pair of cylindrical portions 25.

In the present embodiment, the thermistor holder 4 brings the thermistor 3 into close contact with the terminal 10 by a reaction force generated when the thermistor holder 4 is pushed outward during assembly to the terminal 10. According to this configuration, no separate component is required for bringing the thermistor 3 into close contact with the terminal 10, and therefore the number of components can be reduced.

In the present embodiment, the terminal 10 has a columnar shape. The thermistor holder 4 includes arc-shaped holding portions 41 and 42 that follow the outer periphery of the terminal 10. The thermistor holder 4 brings the thermistor 3 into close contact with the terminal 10 by a reaction force generated when the holding portions 41 and 42 are pushed outward during assembly to the terminal 10. According to this configuration, the contact between the outer peripheral portion of the terminal 10 and the inner peripheral portions of the holding portions 41 and 42 allows the reaction force of the holding portions 41 and 42 to be generated more stably.

### Modification Examples

In the above-described embodiment, an example has been described in which the notches are formed at least at positions facing each other in a direction intersecting the axial direction of the cylindrical portion, but the present invention is not limited to this example. For example, the notch may be formed at a position on one side in a direction intersecting the axial direction of the cylindrical portion. The notch needs only to be formed in the cylindrical portion in such a manner that it is open to allow the thermistor holder to be pushed in when the thermistor holder is inserted. The position where the notch is formed can be changed according to the design specifications.

In the above-described embodiment, an example has been described in which the notch is formed in a range of a central angle of 180 degrees or more when viewed from the axial direction of the cylindrical portion, but the present invention is not limited to this example. For example, the notch may be formed within a range of a central angle of less than 180 degrees when viewed from the axial direction of the cylindrical portion. For example, a plurality of notches may be formed at intervals in the circumferential direction of the cylindrical portion. For example, the notch may be formed continuously in the circumferential direction of the cylindrical portion. For example, the notch may be formed discontinuously (intermittently) in the circumferential direction of the cylindrical portion. The range in which the notch is formed can be changed according to the design specifications.

In the above-described embodiment, an example has been described in which the notch is formed in a portion different from the portion where the pair of cylindrical portions are adjacent to each other, but the present invention is not limited to this example. For example, the notch may be formed in a portion where the pair of cylindrical portions are adjacent to each other. For example, the notch may be formed in one of the pair of cylindrical portions and may not be formed in the other. The manner in which the notch is formed in the pair of cylindrical portions can be changed according to design specifications.

In the above-described embodiment, an example has been described in which the case further includes an insulating wall portion at a portion where the pair of cylindrical portions are adjacent to each other, but the present invention is not limited to this example. For example, the case may not include an insulating wall portion at a portion where the pair of cylindrical portions are adjacent to each other. The manner in which the insulating wall portion is installed can be changed according to the design specifications.

In the above-described embodiment, an example has been described in which the thermistor holder brings the thermistor into close contact with the terminal by a reaction force generated when the thermistor holder is pushed outward during assembly to the terminal, but the present invention is not limited to this example. For example, the connector structure may include a separate component for bringing the thermistor into close contact with the terminal. The manner for bringing the thermistor into close contact with the terminal can be changed according to the design specifications.

In the above-described embodiment, an example has been described in which the terminal has a columnar shape and the thermistor holder includes an arc-shaped holding portion that follows the outer periphery of the terminal, but the present invention is not limited to this example. For example, the holding portion may have a shape other than an arc shape that follows the outer periphery of the terminal. For example, the thermistor holder needs only to have a shape that allows it to come into contact with the outer periphery of the terminal. The shape of the holding portion can be changed according to the design specifications.

Although the embodiments and modification examples have been described above, the embodiments and modification examples are not limited to these examples. The embodiments and modification examples may be modified by addition, omission, substitution, or other changes to the configuration, and may be combined with each other, without departing from the spirit of the present invention.

### Reference Signs List

1 Connector structure

2 Case

3 Thermistor

4 Thermistor holder

10 Terminal

25 Cylindrical portion

26 Notch

27 Wall portion

41, 42 Holding portion

A Central angle

What is claimed is:

1. A connector structure comprising:
a case that holds a terminal;
a thermistor capable of detecting a temperature of the terminal; and
a thermistor holder that brings the thermistor into close contact with the terminal,
wherein the case includes an insulating cylindrical portion into which the thermistor holder is inserted, and
a notch is formed in the cylindrical portion, the notch being open to allow the thermistor holder to be pushed in when the thermistor holder is inserted.

2. The connector structure according to claim 1, wherein
the notch is formed at least at a position facing each other in a direction intersecting an axial direction of the cylindrical portion.

3. The connector structure according to claim 2, wherein
the notch is formed within a range of a central angle of 180 degrees or more when viewed from the axial direction.

4. The connector structure according to claim 1, wherein
a pair of the cylindrical portions are provided adjacent to each other, and
the notch is formed in a portion different from a portion where the pair of cylindrical portions are adjacent to each other.

5. The connector structure according to claim 4, wherein
the case further includes an insulating wall portion at the portion where the pair of cylindrical portions are adjacent to each other.

6. The connector structure according to claim 1, wherein
the thermistor holder brings the thermistor into close contact with the terminal by a reaction force generated when the thermistor holder is pushed outward during assembly to the terminal.

7. The connector structure according to claim 6, wherein
the terminal has a columnar shape,
the thermistor holder includes an arc-shaped holding portion that follows an outer periphery of the terminal, and
the thermistor holder brings the thermistor into close contact with the terminal by a reaction force generated when the holding portion is pushed outward during assembly to the terminal.
